(19) United States
(12) Patent Application Publication
(10) Pub. No.: US 2013/0128953 A1
(43) Pub. Date: May 23, 2013

(54) REPRODUCTION APPARATUS, REPRODUCTION METHOD, AND PROGRAM

(71) Applicant: Sony Corporation, Tokyo (JP)

(72) Inventor: Yutaka Sonoda, Tokyo (JP)

(73) Assignee: Sony Corporation, Tokyo (JP)

(21) Appl. No.: 13/676,476

(22) Filed: Nov. 14, 2012

(30) Foreign Application Priority Data
Nov. 21, 2011 (JP) 2011-253866

(51) Int. Cl. H04N 7/26

(52) U.S. Cl. CPC H04N 19/00533
USPC 375/240.02

(57) ABSTRACT

A reproduction apparatus is disclosed which includes: an acquisition part configured to acquire a transmitted stream; a buffer configured to store the acquired stream; and a decoding part configured to perform the process of decoding the stream coming from the buffer. The reproduction apparatus further includes a control part configured such that if the amount of the stream occupying the buffer is below a predetermined reference value, the control part controls the frame rate of frames for reproduction acquired through the decoding process to be a lower frame rate than normal and that if the amount of the stream occupying the buffer reaches the reference value, the control part controls the frame rate of the frames to become the normal frame rate.

### BACKGROUND

The present disclosure relates to a reproduction apparatus, a reproduction method, and a program. More particularly, the disclosure relates to a reproduction apparatus, a reproduction method, and a program for implementing real-time reproduction by starting to reproduce a given channel without delay upon channel selection.

Generally, digital broadcast reception apparatuses receiving digital television broadcasts are equipped with a stream buffer to store and reproduce a data stream while dealing with transmission jitter. Immediately after the selection of a given channel, the buffer is empty. It follows that there occurs a delay before a predetermined amount of a data stream is buffered following channel selection preparatory to starting reproduction.

Japanese Patent Laid-open No. 2009-171024 (called Patent Document 1 hereunder), for example, discloses a technique for solving the problem of such delay. The disclosed technique involves a digital broadcast reception apparatus which, upon channel selection, performs reproduction at a lower speed than normal until a sufficient amount of a data stream is accumulated in the buffer.

### SUMMARY

Upon channel selection, the digital broadcast reception apparatus disclosed in Patent Document 1 delays the time of decoding and displaying video data as well as the time of outputting audio data for reproduction at a lower speed than normal. This makes it possible to provide video and audio output at channel selection.

However, what the disclosed digital broadcast reception apparatus carries out upon channel selection is slow reproduction; it cannot output images and sounds in real time.

The present disclosure has been made in view of the above circumstances and provides innovative arrangements for implementing real-time reproduction by starting to reproduce a given channel without delay upon channel selection.

According to one mode of the present disclosure, there is provided a reproduction apparatus including: an acquisition part configured to acquire a transmitted stream; a buffer configured to store the acquired stream; a decoding part configured to perform the process of decoding the stream coming from the buffer, and a control part configured such that if the amount of the stream occupying the buffer is below a predetermined reference value, the control part controls the frame rate of frames for reproduction acquired through the decoding process to be a lower frame rate than normal and that if the amount of the stream occupying the buffer reaches the reference value, the control part controls the frame rate of the frames to become the normal frame rate.

Preferably, if the amount of the stream occupying the buffer is below the reference value, the control part may vary the lower frame rate steplessly in accordance with the ratio of the amount of the stream occupying the buffer to the capacity of the buffer.

Preferably, the reproduction apparatus may further include a video conversion part configured such that if the amount of the stream occupying the buffer is below the reference value, the video conversion part may generate interpolation frames using those video frames at the lower frame rate which are acquired through the decoding process and insert the generated interpolation frames into the video frames at the lower frame rate for frame rate conversion.

Preferably, the video conversion part may generate the interpolation frames and insert the generated interpolation frames into the video frames at the lower frame rate for conversion into the normal frame rate.

Preferably, the reproduction apparatus may further include an audio conversion part configured such that if the amount of the stream occupying the buffer is below the reference value, the audio conversion part may convert the pitch of an audio signal corresponding to audio frames synchronized with those video frames at the lower frame rate which are acquired through the decoding process, thereby raising the audio pitch.

Preferably, the reproduction apparatus may be a reception apparatus configured to receive a digital television broadcast signal, and the acquisition part may acquire a digital television broadcast stream corresponding to a selected channel.

The reproduction apparatus may be either an independent apparatus or an internal block constituting part of an apparatus.

According to other modes of the present disclosure, there are provided a reproduction method and a program functionally corresponding to the above-outlined reproduction apparatus.

Through the use of the reproduction apparatus, reproduction method, and program according to modes of the present disclosure, the transmitted stream is first acquired. The acquired stream is stored into the buffer before being decoded through the decoding process. While the amount of the stream occupying the buffer is below the predetermined reference value, the frame rate of the frames for reproduction acquired through the decoding process is controlled to be a lower frame rate than normal. When the amount of the stream occupying the buffer reaches the reference value, the lower frame rate is controlled to become the normal frame rate.

Thus according to the modes of the present disclosure, it is possible to implement real-time reproduction by starting to reproduce a selected channel without delay upon channel selection.

### BRIEF DESCRIPTION OF THE DRAWINGS

FIG. 1 is a schematic view showing a structure of a digital broadcast reception apparatus as a first embodiment of the present disclosure;

FIG. 2 is a flowchart showing a reproduction process;

FIG. 3 is a flowchart showing a video decoding conversion process;

FIG. 4 is a flowchart showing an audio decoding conversion process;

FIG. 5 is a schematic view showing a structure of a communication apparatus as a second embodiment of the present disclosure; and

FIG. 6 is a block diagram showing a typical configuration of a computer.

### DETAILED DESCRIPTION OF THE PREFERRED EMBODIMENTS

Some preferred embodiments of the present disclosure will now be described below in reference to the accompanying drawings.

### First Embodiment

### [Typical Structure of the Digital Broadcast Reception Apparatus]

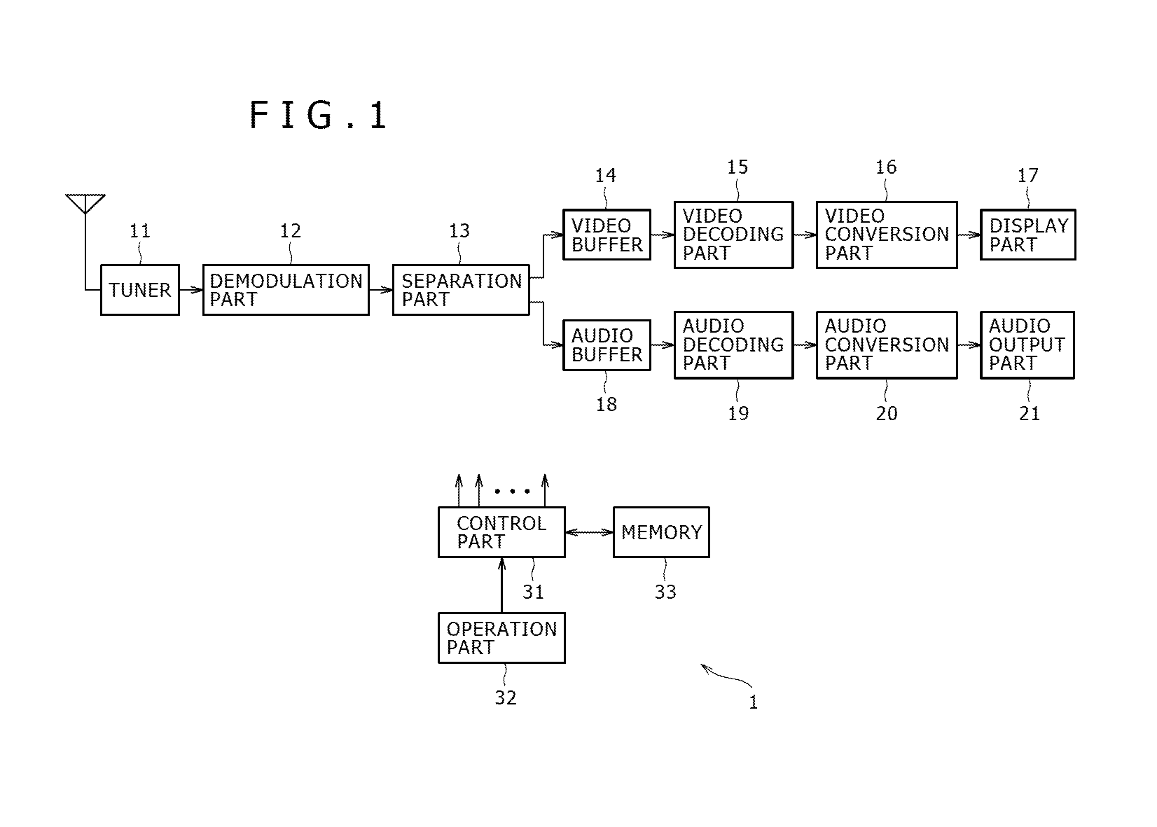

FIG. 1 is a schematic view showing a structure of a digital broadcast reception apparatus 1 as a first embodiment of the present disclosure.

The digital broadcast reception apparatus 1 includes a tuner 11, a demodulation part 12, a separation part 13, a video buffer 14, a video decoding part 15, a video conversion part 16, a display part 17, an audio buffer 18, an audio decoding part 19, an audio conversion part 20, an audio output part 21, a control part 31, an operation part 32, and a memory 33.

A digital TV broadcast signal (RF (Radio Frequency) signal) received by an antenna (not shown) is input to the tuner 11. The tuner 11 frequency-converts the RF signal input from the antenna into an IF (Intermediate Frequency) signal that is output to the demodulation part 12.

The demodulation part 12 performs predetermined demodulation processing such as OFDM (Orthogonal Frequency Division Multiplexing) demodulation and predetermined error correction processing on the IF signal input from the tuner 11 so as to obtain a transport stream. The demodulation part 12 outputs the transport stream thus acquired to the separation part 13.

The separation part 13 separates the transport stream input from the demodulation part 12 into a video stream and an audio stream. The separation part 13 outputs the separated video stream to the video buffer 14 and the separated audio stream to the audio buffer 18.

The video buffer 14 under control of the control part 31 successively stores the video stream input from the separation part 13. The video stream stored in the video buffer 14 is output consecutively to the video decoding part 15.

The video decoding part 15 under control of the control part 31 decodes the video stream input from the video buffer 14. The video decoding part 15 outputs the video frames acquired through decoding to the video conversion part 16.

The video conversion part 16 under control of the control part 31 generates interpolation frames using the video frames input from the video decoding part 15, and inserts the generated interpolation frames into the video frames for frame rate conversion. The technique of interpolating frames between the original frames to convert the frame rate is also called FRC (Frame Rate Conversion).

The video conversion part 16 outputs to the display part 17 a video signal corresponding to the converted video frames. If there is no need to convert the frame rate of the video frames, the video conversion part 16 under control of the control part 31 outputs the video signal corresponding to the video frames from the video decoding part 15 unmodified to the display part 17.

The display part 17 may be composed of a display unit, for example. The display part 17 displays an image corresponding to the video signal input from the video conversion part 16.

The audio buffer 18 under control of the control part 31 successively stores the audio stream input from the separation part 13. The audio stream stored in the audio buffer 18 is output consecutively to the audio decoding part 19.

The audio decoding part 19 under control of the control part 31 decodes the audio stream input from the audio buffer 18. The audio decoding part 19 outputs the audio frames acquired through decoding to the audio conversion part 20.

The audio conversion part 20 under control of the control part 31 converts the pitch of the audio signal corresponding to the audio frames input from the audio decoding part 19.

The audio conversion part 20 outputs the converted audio signal to the audio output part 21. If there is no need to convert the pitch of the audio signal, the audio conversion part 20 under control of the control part 31 outputs the audio signal corresponding to the audio frames from the audio decoding part 19 unmodified to the audio output part 21.

The audio output part 21 may be composed of speakers, for example. The audio output part 21 outputs a sound corresponding to the audio signal input from the audio conversion part 20.

The control part 31 controls the operations of the components making up the digital broadcast reception apparatus 1 by carrying out the control programs recorded in the memory 33. The operation part 32 accepts diverse operations from a user and outputs operation signals reflecting the user's operations to the control part 31. In turn, the control part 31 controls the operations of the components constituting the digital broadcast reception apparatus 1 in accordance with the operation signals coming from the operation part 32.

Also, the control part 31 continuously monitors the amount of the video stream occupying the video buffer 14 and, in keeping with the result of the monitoring, controls the video decoding part 15 performing the process of decoding the video stream and the video conversion part 16 carrying out the process of converting the frame rate of the video frames. Furthermore, the control part 31 continuously monitors the amount of the audio stream occupying the audio buffer 18 and, in accordance with the result of the monitoring, controls the audio decoding part 19 performing the process of decoding the audio stream and the audio conversion part 20 carrying out the process of converting the pitch of the audio signal.

The control part 31 of this embodiment monitors both the video buffer 14 and the audio buffer 18. Alternatively, the control part 31 may monitor solely the video buffer 14 or the audio buffer 18 and control the decoding and conversion processes in accordance with the result of the monitoring. Also, whereas this embodiment is shown to have the video buffer 14 and audio buffer 18 provided separately, these buffers may alternatively be integrated into a single part.

The digital broadcast reception apparatus 1 is structured as described above.

### [Reproduction Process]

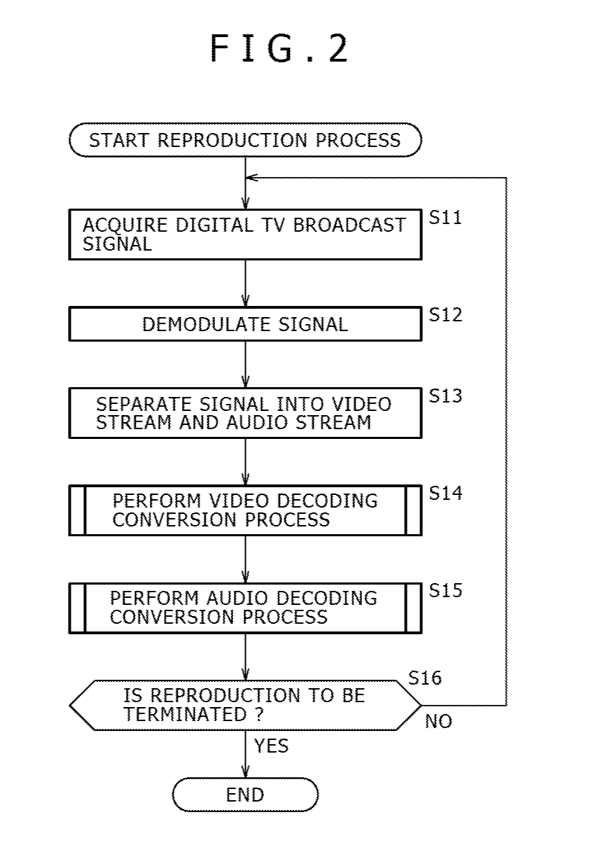

The reproduction process performed by the digital broadcast reception apparatus 1 is explained below in reference to the flowchart of FIG. 2.

In step S11, the tuner 11 acquires a digital TV broadcast signal (RF signal) received by the antenna (not shown). The tuner 11 frequency-converts the RF signal into an IF signal and outputs the IF signal to the demodulation part 12.

In step S12, the demodulation part 12 performs demodulation processing such as OFDM demodulation and error correction processing on the IF signal coming from the tuner 11. The demodulation part 12 proceeds to output a transport stream obtained through the processing to the separation part 13.

In step S13, the separation part 13 separates the transport stream from the demodulation part 12 into a video stream and an audio stream. The video stream separated by the separation part 13 is stored successively into the video buffer 14. The audio stream separated by the separation part 13 is stored consecutively into the audio buffer 18.

In step S14, the video decoding part 15 and video conversion part 16 under control of the control part 31 carry out a video decoding conversion process involving the decoding and conversion of video data.

Here, the control part 31 continuously monitors the video buffer 14 and, depending on whether or not the amount of the video stream occupying the video buffer 14 has reached a predetermined reference value (ratio), controls the video decoding part 15 and video conversion part 16 carrying out the video decoding conversion process accordingly. That is, if the amount of the video stream occupying the video buffer 14 is below the predetermined reference value, the video decoding part 15 and video conversion part 16 under control of the control part 31 perform the video decoding conversion process in such a manner that the frame rate of the video frames is set to a lower frame rate than normal (called the lower frame rate hereunder). If the amount of the video stream occupying the video buffer 14 reaches the predetermined reference value, the video decoding part 15 and video conversion part 16 under control of the control part 31 carry out the video decoding conversion process in such a manner that the frame rate of the video frames is set to a frame rate in normal mode (called the normal frame rate hereunder).

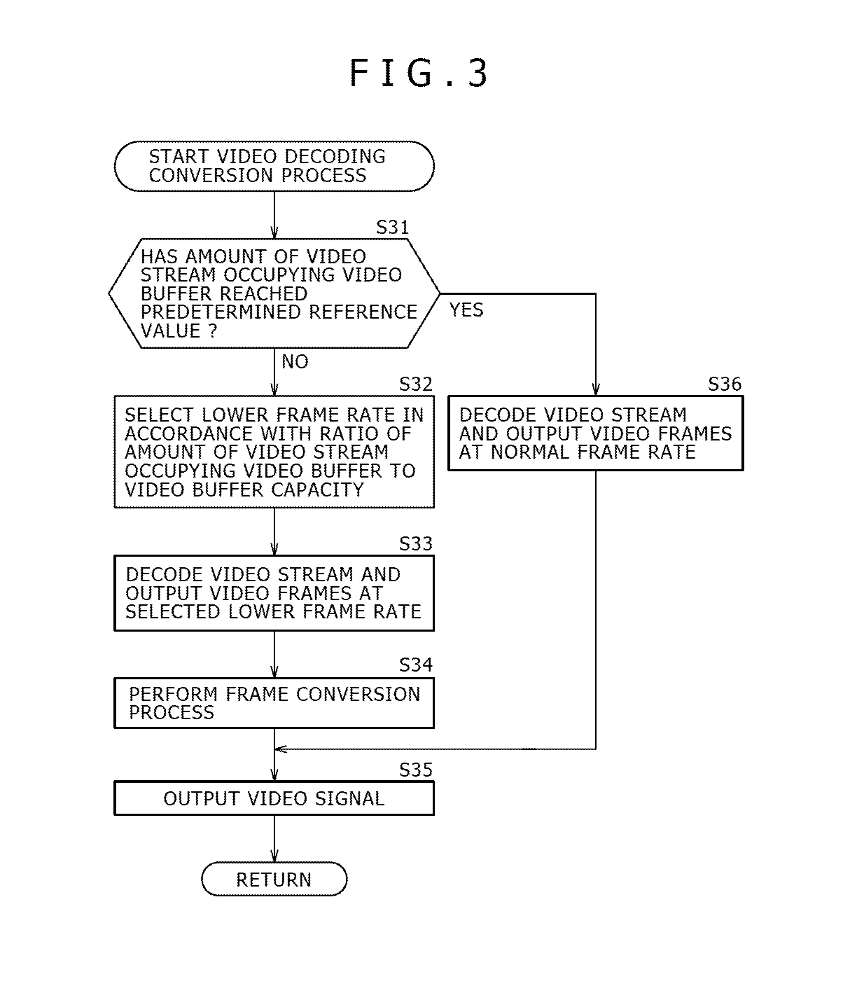

The video decoding conversion process above will be discussed later in detail by referring to the flowchart of FIG. 3.

In step S15, the audio decoding part 19 and audio conversion part 20 under control of the control part 31 carry out an audio decoding conversion process involving the decoding and conversion of audio data.

Here, the control part 31 continuously monitors the audio buffer 18 and, depending on whether or not the amount of the audio stream occupying the audio buffer 18 has reached a predetermined reference value (ratio), controls the audio decoding part 19 and audio conversion part 20 carrying out the audio decoding conversion process accordingly. That is, if the amount of the audio stream occupying the audio buffer 18 is below the predetermined reference value, the audio decoding part 19 and audio conversion part 20 under control of the control part 31 perform the audio decoding conversion process in such a manner that the frame rate of the audio frames is set to the lower frame rate. If the amount of the audio stream occupying the audio buffer 18 reaches the predetermined reference value, the audio decoding part 19 and audio conversion part 20 under control of the control part 31 carry out the audio decoding conversion process in such a manner that the frame rate of the audio frames is set to the normal frame rate.

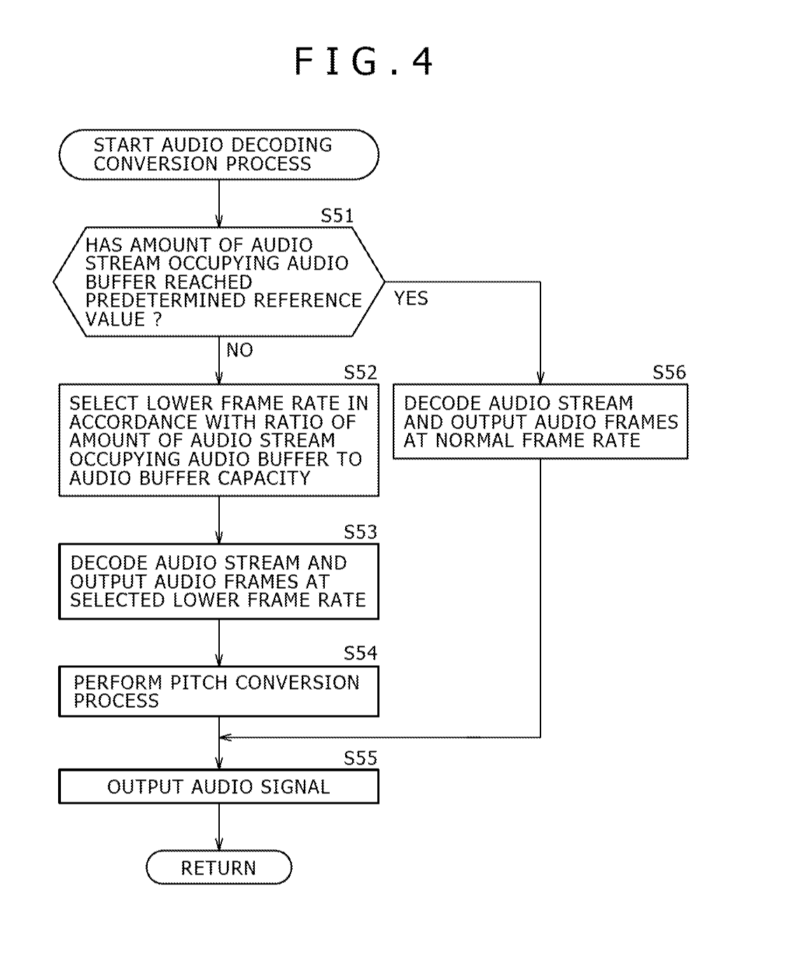

The audio decoding conversion process above will be discussed later in detail by referring to the flowchart of FIG. 4.

For convenience of explanation, the audio decoding conversion process of step S15 is shown carried out following the video decoding conversion process of step S14. In practice, however, the video decoding conversion process and audio decoding conversion process are performed in parallel fashion.

In step S16, the control part 31 determines whether or not to terminate video reproduction in accordance with the operation signal coming from the operation part 32. If it is determined in step S16 that video reproduction is not to be terminated, control is returned to step S11 and the subsequent steps are repeated.

That is, when a sufficient amount of the stream has yet to be stored into each buffer upon channel selection, for example, steps S11 through S16 are repeated. Reproduction is thus carried out at the lower frame rate until the amount of the stream occupying each buffer reaches the predetermined reference value. With reproduction conducted at the lower frame rate, the stream is gradually accumulated in each buffer. When the amount of the stream occupying each buffer reaches the predetermined reference value, reproduction is carried out at the normal frame rate.

If it is determined in step S16 that reproduction is to be terminated, then the reproduction process of FIG. 2 is brought to an end.

This completes the explanation of the reproduction process continued from the preceding paragraphs.

### [Video Decoding Conversion Process]

Explained next in reference to the flowchart of FIG. 3 is the video decoding conversion process corresponding to step S14 in FIG. 2.

In step S31, the control part 31 determines whether the amount of the video stream occupying the video buffer 14 has reached the predetermined reference value.

Here, the reference value is a value for determining whether or not reproduction at the normal frame rate is possible. The reference value is established as a value obtained as representative of an area which is near the half-size position (half position) of the storage area making up the video buffer 14 and which constitutes a stable buffer capacity with some margin. For example, the reference value may be determined as a value such that the amount of the video stream occupying the video buffer 14 becomes 50%.

The reference value may be altered in accordance with the amount of jitter that varies depending on the status of broadcast networks, communication networks, etc. Also, since reproduction is performed at the lower frame rate by this embodiment until the amount of the video stream occupying the buffer reaches the predetermined reference value, the reference value may be altered in keeping with the frame rate.

Upon channel selection, for example, the video stream of the selected channel has yet to be accumulated in the video buffer 14 and the amount of the video stream occupying the buffer has not reached the predetermined reference value. In such a case, control is passed to step S32.

In step S32, the control part 31 determines the lower frame rate of the video frames to be obtained from the decoding process by the video decoding part 15 in keeping with the ratio of the amount of the video stream occupying the video buffer 14 to the video buffer capacity. Here, if the normal frame rate is 60 fps (frames per second) and if no video stream is stored in the video buffer 14 at channel selection, the control part 31 determines 30 fps as the lower frame rate.

In step S33, the video decoding part 15 under control of the control part 31 successively decodes the video stream output from the video buffer 14 and outputs to the video conversion part 16 the video frames at the lower frame rate obtained through the decoding process. Here, the video frames are output to the video conversion part 16 at a lower frame rate of, say, 30 fps determined by the control part 31 in step S32.

In step S34, the video conversion part 16 generates interpolation frames using the video frames at the lower frame rate from the video decoding part 15, and inserts the generated interpolation frames into the video frames at the lower frame rate for frame rate conversion. Specifically, using the block matching method, gradient method or the like, the video conversion part 16 detects motion vector information from the video frames coming from the video decoding part 15. And using the detected motion vector information for motion compensation, the video conversion part 16 successively outputs interpolation frames interpolating the original frames (i.e., video frames from the video decoding part 15) along with the original frames. In this manner, the video conversion part 16 converts the frame rate of the video frames from 30 fps to 60 fps, for example.

In step S35, the video conversion part 16 outputs to the display part 17 a video signal corresponding to the converted video frames obtained through the frame conversion process in step S34. This makes it possible to smooth out video motion during reproduction, the video moving at a little lower speed than if the video were reproduced at the normal frame rate.

At the end of the process in step S35, control is returned to step S14 in FIG. 2 and the subsequent steps are repeated. That is, the video decoding conversion process of FIG. 3 corresponding to step S14 in FIG. 2 is repeated until it is determined in step S16 of FIG. 2 that video reproduction is to be terminated.

Every time the video decoding conversion process of FIG. 3 is carried out, it is determined whether or not the amount of the video stream occupying the video buffer 14 has reached the predetermined reference value. If the amount of the video stream occupying the buffer has yet to reach the reference value, a lower frame rate corresponding to the buffer occupancy ratio is determined. The video frames are then decoded at the determined lower frame rate in a frame conversion process. For example, since the amount of the video stream occupying the video buffer 14 rises over time, the control part 31 may determine that the rate of the lower frame rate is to be gradually raised in accordance with the increase in the buffer occupancy ratio. That is, the lower frame rate determined by the control part 31 is set to approach the normal frame rate in accordance with an increasing amount of the video frames occupying the video buffer over time.

Alternatively, the lower frame rate may be initially set to a predetermined fixed value. Over time, the frame rate may be raised in increments of a predetermined value so that the rate will eventually become equal to the normal frame rate.

Thereafter, the video stream is accumulated into the video buffer 14 and reproduction is continued at the lower frame rate. When it is determined in step S31 that the amount of the video stream occupying the video buffer 14 has reached the predetermined reference value, control is passed to step S36.

In step S36, the video decoding part 15 under control of the control part 31 successively decodes the video stream output from the video buffer 14. The video decoding part 15 outputs the video frames at the normal frame rate obtained through the decoding process to the video conversion part 16.

Here, the video frames are output to the video conversion part 16 at the normal frame rate of, say, 60 fps. Since there is no need for the video conversion part 16 to perform the frame conversion process during reproduction at the normal frame rate, the video conversion part 16 outputs the video signal corresponding to the video frames from the video decoding part 15 unmodified to the display part 17. This permits video reproduction at the normal frame rate. Because the lower frame rate is altered steplessly in accordance with the amount of the video frames occupying the buffer, a feeling of awkwardness experienced upon changeover from the lower frame rate to the normal frame rate is eliminated compared with the case where the lower frame rate is changed in steps.

When the amount of the video stream occupying the video buffer 14 has reached the predetermined reference value, that means a sufficient amount of the video stream needed for reproduction has been accumulated in the video buffer 14. In that case, reproduction is continued basically at the normal frame rate thereafter.

This completes the explanation of the video decoding conversion process continued from the preceding paragraphs.

### [Audio Decoding Conversion Process]

Explained next in reference to the flowchart of FIG. 4 is the audio decoding conversion process corresponding to step S15 in FIG. 2.

In step S51, the control part 31 determines whether the amount of the audio stream occupying the audio buffer 18 has reached a predetermined reference value (e.g., a 50% buffer occupancy ratio that means the audio stream occupying 50% of the audio buffer 18). Upon channel selection, for example, no audio stream of the selected channel is accumulated in the audio buffer 18 and the buffer occupancy ratio is below the reference value. In such a case, control is passed to step S52.

In step S52, the control part 31 determines the lower frame rate for the audio frames obtained through the decoding process by the audio decoding part 19 in accordance with the ratio of the amount of the audio stream occupying the audio buffer 18 to the audio buffer capacity. For example, if the normal sampling frequency is 48 kHz and if no audio stream is accumulated in the audio buffer 18 upon channel selection, the control part 31 may determine 24 kHz as the sampling frequency.

In step S53, the audio decoding part 19 under control of the control part 31 successively decodes the audio stream output from the audio buffer 18, and outputs the audio frames at the lower frame rate obtained through the decoding process to the audio conversion part 20. Here, the audio frames are output to the audio conversion part 20 with the sampling frequency of, say, 24 kHz determined by the control part 31 in step S52.

In step S54, the audio conversion part 20 performs a pitch conversion process on the audio signal corresponding to the audio frames coming from the audio decoding part 19 at the lower frame rate. Specifically, if the sampling frame is changed from 48 kHz to 24 kHz for example, the audio pitch drops. In order to let the user hear the audio without a feeling of awkwardness, the drop in the audio pitch needs to be suppressed. This involves getting the audio conversion part 20 to raise the audio pitch by converting the pitch of the audio signal corresponding to the audio frames, until the pitch of the reproduced audio becomes the same as that in normal reproduction, for example.

In step S55, the audio conversion part 20 outputs the converted audio signal obtained through the pitch conversion process to the audio output part 21. This suppresses the drop in the pitch of the audio that is output in synchronism with the currently reproduced video.

At the end of the process in step S55, control is returned to step S15 in FIG. 2, and the subsequent steps are repeated. That is, the audio decoding conversion process of FIG. 4 corresponding to step S15 in FIG. 2 is repeated until it is determined in step S16 of FIG. 2 that video reproduction is to be terminated. Every time the audio decoding process of FIG. 4 is carried out, it is determined whether or not the amount of the audio stream occupying the audio buffer 18 has reached the predetermined reference value. If the buffer occupancy ratio has yet to attain the predetermined reference value, the lower frame rate is determined in accordance with the buffer occupancy ratio in effect. The audio frames at the determined lower frame rate are then decoded and the pitch conversion process is carried out.

Thereafter, with the audio stream accumulated into the audio buffer 18 and with reproduction continued at the lower frame rate, it will be determined in step S51 that the amount of the audio stream occupying the audio buffer 18 has reached the predetermined reference value. In that case, control is passed to step S56.

In step S56, the audio decoding part 19 under control of the control part 31 successively decodes the audio stream output from the audio buffer 18, and outputs the audio frames at the normal frame rate obtained through the decoding process to the audio conversion part 20.

In this case, the audio frames are output at the normal frame rate to the audio conversion part 20 with the sampling frequency of 48 kHz, for example. Since there is no need for the audio conversion part 20 to perform the pitch conversion process during reproduction at the normal frame rate, the audio conversion part 20 outputs the audio signal corresponding to the audio frames from the audio decoding part 19 unmodified to the audio output part 21. This permits audio reproduction at the normal frame rate.

When the amount of the audio stream occupying the audio buffer 18 has reached the predetermined reference value, that means a sufficient amount of the audio stream necessary for reproduction has been accumulated in the audio buffer 18. In that case, reproduction is continued basically at the normal frame rate thereafter.

This completes the explanation of the audio decoding conversion process continued from the preceding paragraphs.

As described above, the digital broadcast reception apparatus 1 continuously monitors the amount of the stream occupying each buffer and, while the buffer occupancy ratio has yet to reach the predetermined reference value, decodes frames at a lower frame rate than normal. Thus upon channel selection, the digital broadcast reception apparatus 1 implements real-time reproduction by starting to reproduce the selected channel without delay.

That is, even if the buffer occupancy ratio has yet to attain the predetermined reference value, it is possible to decode the frames at the lower frame rate and continue reproduction. For example, where the stream has not been stored yet in the buffer at channel selection, it is possible immediately to start real-time reproduction without waiting for the stream to be accumulated into the buffer. This makes it possible to reproduce the program of a given channel in real time without delay as soon as the channel is changed.

At this point, the digital broadcast reception apparatus 1 carries out both the frame conversion process and the pitch conversion process. It is thus possible to reproduce images and sounds in real time without a feeling of awkwardness as in normal reproduction even upon channel selection.

At channel selection, the frames are decoded at the lower frame rate, so that the amount of the stream accumulated into the buffer can be raised while the amount of the stream read out of the buffer is reduced. This makes it possible to avert the occurrence of a buffer underflow. It is also possible to shorten the time it takes to accumulate the amount of the stream necessary for performing reproduction at the normal frame rate, so that reproduction can be started rapidly at the usual frame rate.

Furthermore, the digital broadcast reception apparatus 1 may be equipped as standard with an FRC circuit providing the above-mentioned FRC function. In this case, the FRC circuit may be utilized as the video conversion part 16. That means the present disclosure may be implemented using existing circuitry, with no new circuits additionally provided.

### Second Embodiment

### [Typical Structure of the Communication Apparatus]

The foregoing paragraphs have explained examples of the digital broadcast reception apparatus 1 receiving digital TV broadcast signals. In another example, the present disclosure may be applied to a communication apparatus that receives content delivered in streaming mode from delivery servers that deliver video on demand (VOD) via the internet.

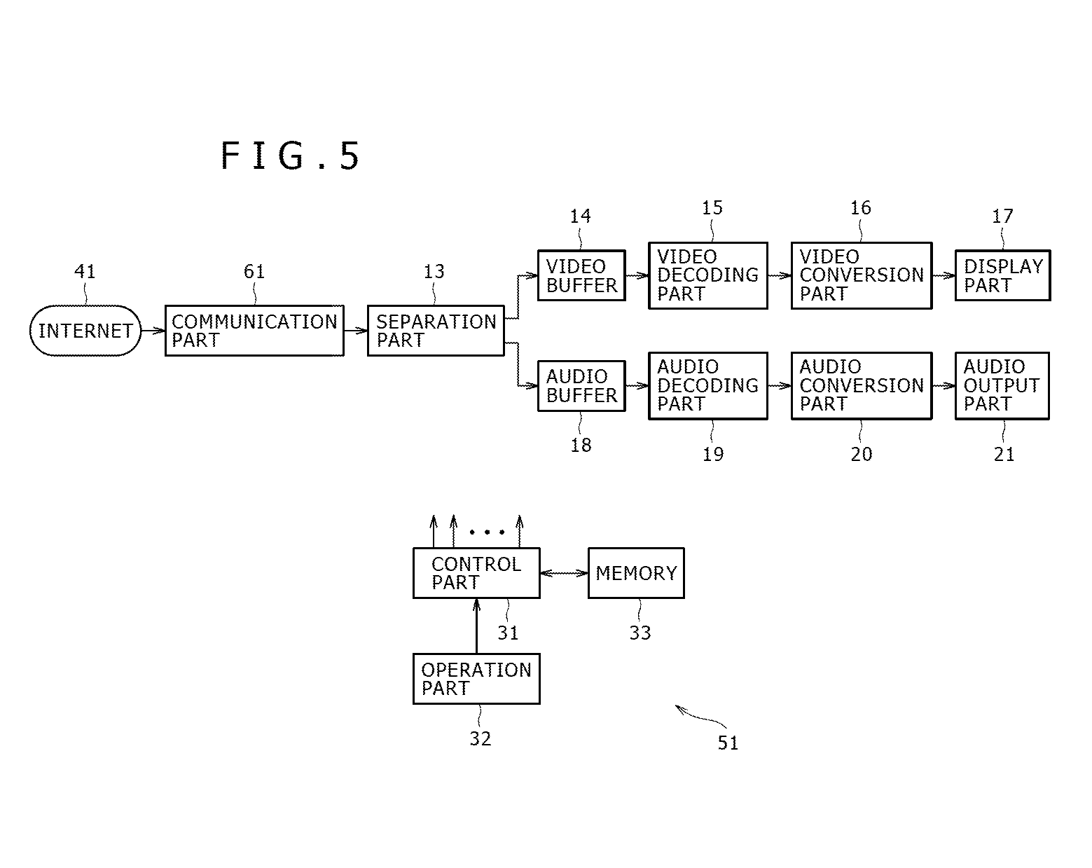

FIG. 5 is a schematic view showing a structure of a communication apparatus 51 as a second embodiment of the present disclosure.

In FIG. 5, the components also found in the structure of FIG. 1 are designated by the same reference numerals, and their explanations may be omitted hereunder where appropriate. That is, the communication apparatus 51 in FIG. 5 has a communication part 61 replacing the tuner 11 and demodulation part 12 of the digital broadcast reception apparatus 1 in FIG. 1, the communication part 61 being used to connect with the Internet 41.

The communication part 51 may be an electronic apparatus such as a personal computer, a tablet computer, a portable terminal device such as a mobile phone and a smartphone capable of connecting with the Internet 41.

The communication part 61 receives over the Internet 41 a stream transmitted in packets from a delivery server and outputs the received stream to the separation part 13. The separation part 13 separates the stream from the communication part 61 into a video stream and an audio stream, and has the separated streams stored into the video buffer 14 and audio buffer 18 respectively.

As discussed above, the control part 31 continuously monitors the amount of the video stream occupying the video buffer 14 and, in accordance with the result of the monitoring, controls the video decoding part 15 and video conversion part 16 carrying out the video decoding conversion process. Also, the control part 31 continuously monitors the amount of the audio stream occupying the audio buffer 18 and, in keeping with the result of the monitoring, controls the audio decoding part 19 and audio conversion part 20 performing the audio decoding conversion process.

The communication apparatus 51 is structured as explained above.

The foregoing paragraphs have explained the digital broadcast reception apparatus 1 and communication apparatus 51 as typical reproduction apparatuses capable of reproducing transmitted streams. However, these examples are not limitative of the present disclosure. This disclosure may also be applied to electronic apparatuses of many other genres capable of reproducing transmitted streams.

[Explanation of the Computer to which the Present Disclosure is Applied]

The series of processing described above may be executed either by hardware or by software. Where the processing is to be carried out by software, the programs constituting the software are installed into a suitable computer for execution. Such computers may include those embedded in dedicated hardware, and those such as general-purpose personal computers capable of executing diverse functions by installing various programs.

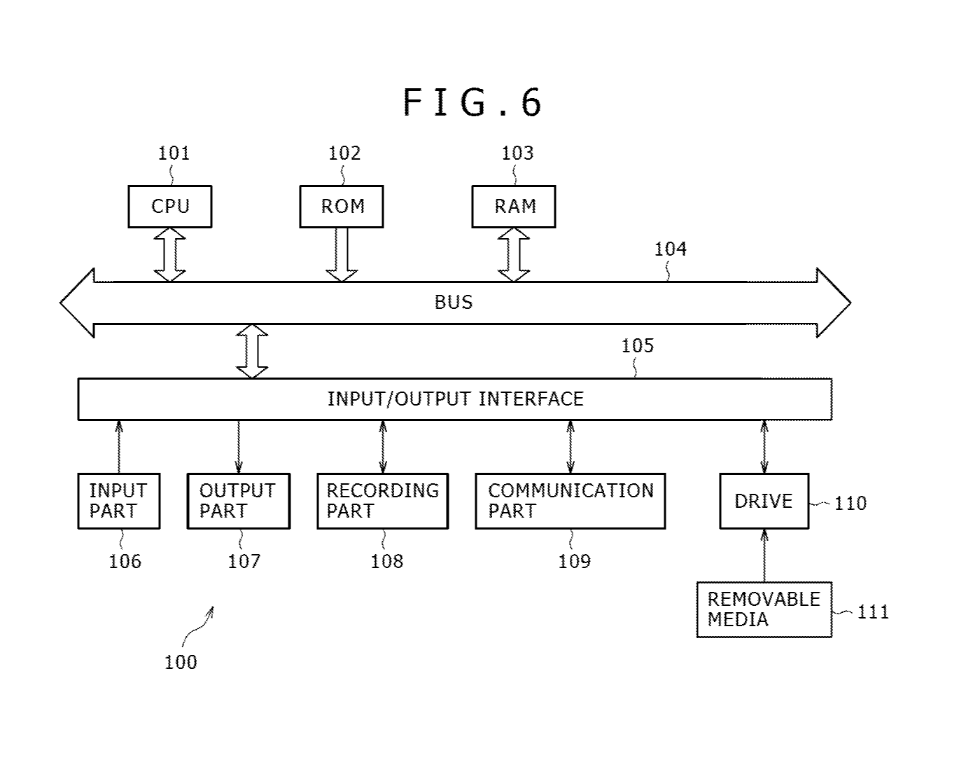

FIG. 6 is a block diagram showing a typical configuration of hardware of a computer 100 that carries out the above-described series of processing using programs.

In the computer 100, a CPU (Central Processing Unit) 101, a ROM (Read Only Memory) 102, and a RAM (Random Access Memory) 103 are interconnected by a bus 104.

An input/output interface 105 is also connected to the bus 104. Furthermore, the input/output interface 105 is connected with an input part 106, an output part 107, a recording part 108, a communication part 109, and a drive 110.

The input part 106 is made up of a keyboard, a mouse, a microphone, etc. The output part 107 is composed of a display unit, speakers, etc. The recording part 108 is formed by a hard disk, a nonvolatile memory, etc. The communication part 109 is typically made of a network interface. The drive 110 drives removable media 111 such as a magnetic disk, an optical disk, a magneto-optical disk, or a semiconductor memory.

In the computer 100 configured as outlined above, the CPU 101 may perform the above-described series of processing by loading programs from the recording part 108 where they are stored into the RAM 103 for execution via the input/output interface 105 and bus 104, for example.

For example, the programs executed by the computer 100 (i.e. CPU 101) may be offered recorded on the removable media 111 constituting package media or the like. The programs may also be offered through wired or wireless communication media such as local area networks, the Internet, and digital satellite broadcasts.

When a suitable piece of the removable media 111 carrying relevant programs is attached to the drive 110 of the computer 100, the programs may be installed from the medium into the recording part 108 through the input/output interface 105. Alternatively, the programs may be received by the communication part 109 through wired or wireless transmission media and installed into the recording part 108. As another alternative, the programs may be preinstalled in the ROM 102 or in the recording part 108.

Also, the programs for execution by the computer 100 may be processed in the depicted sequence of this specification (i.e., on a time series basis), in parallel, or in otherwise appropriately timed fashion such as when they are invoked as needed.

In this specification, the processing steps that describe the programs for causing the computer 100 to perform diverse operations may not be carried out in the depicted sequence in the flowcharts (i.e., on a time series basis); the steps may also include processes that are conducted parallelly or individually (e.g., in parallel or object-oriented fashion).

Furthermore, the programs may be processed by a single computer or by a plurality of computers on a distributed basis. The programs may also be transferred to a remote computer or computers for execution.

It should be understood that the present disclosure when embodied is not limited to the above-described embodiments and that various modifications, variations and alternatives may be made of this disclosure so far as they are within the scope of the appended claims or the equivalents thereof.

For example, the present disclosure may be implemented using a cloud-computing configuration in which one function is processed by a plurality of apparatuses in a shared and cooperative manner via networks.

Also, each of the steps explained in connection with the above-described flowcharts may be carried out not only by a single apparatus but also by a plurality of apparatuses on a shared basis.

Furthermore, if one step includes a plurality of processes, these processes may be performed not only by a single apparatus but also by a plurality of apparatuses on a shared basis.

The present disclosure may be configured as follows:

(1) A reproduction apparatus including:

an acquisition part configured to acquire a transmitted stream;

a buffer configured to store the acquired stream;

a decoding part configured to perform the process of decoding the stream coming from the buffer; and

a control part configured such that if the amount of the stream occupying the buffer is below a predetermined reference value, the control part controls the frame rate of frames for reproduction acquired through the decoding process to be a lower frame rate than normal and that if the amount of the stream occupying the buffer reaches the reference value, the control part controls the frame rate of the frames to become the normal frame rate.

(2) The reproduction apparatus described in paragraph (1) above, wherein, if the amount of the stream occupying the buffer is below the reference value, the control part varies the lower frame rate continuously in accordance with the ratio of the amount of the stream occupying the buffer to the capacity of the buffer.

(3) The reproduction apparatus described in paragraph (1) or (2) above, further including a video conversion part configured such that if the amount of the stream occupying the buffer is below the reference value, the video conversion part generates interpolation frames using those video frames at the lower frame rate which are acquired through the decoding process and inserts the generated interpolation frames into the video frames at the lower frame rate for frame rate conversion.

(4) The reproduction apparatus described in paragraph (3) above, wherein the video conversion part generates the interpolation frames and inserts the generated interpolation frames into the video frames at the lower frame rate for conversion into the normal frame rate.

(5) The reproduction apparatus described in paragraph (3) or (4) above, further including an audio conversion part configured such that if the amount of the stream occupying the buffer is below the reference value, the audio conversion part converts the pitch of an audio signal corresponding to audio frames synchronized with those video frames at the lower frame rate which are acquired through the decoding process, thereby raising the audio pitch.

(6) The reproduction apparatus described in any one of paragraphs (1) through (5) above, wherein the reproduction apparatus is a reception apparatus configured to receive a digital television broadcast signal, and the acquisition part acquires a digital television broadcast stream corresponding to a selected channel.

(7) A reproduction method for use with a reproduction apparatus having a buffer, the reproduction method including

causing the reproduction apparatus to:
acquire a transmitted stream;
store the acquired stream into the buffer;
perform the process of decoding the stream coming from the buffer;
if the amount of the stream occupying the buffer is below a predetermined reference value, then control the frame rate of frames for reproduction acquired through the decoding process to be a lower frame rate than normal; and
if the amount of the stream occupying the buffer reaches the reference value, then control the frame rate of the frames to become the normal frame rate.

(8) A program for causing a computer to function as:

an acquisition part configured to acquire a transmitted stream;

a buffer configured to store the acquired stream;

a decoding part configured to perform the process of decoding the stream coming from the buffer; and

a control part configured such that if the amount of the stream occupying the buffer is below a predetermined reference value, the control part controls the frame rate of frames for reproduction acquired through the decoding process to be a lower frame rate than normal and that if the amount of the stream occupying the buffer reaches the reference value, the control part controls the frame rate of the frames to become the normal frame rate.

The present disclosure contains subject matter related to that disclosed in Japanese Priority Patent Application JP 2011-253866 filed in the Japan Patent Office on Nov. 21, 2011, the entire content of which is hereby incorporated by reference.

What is claimed is:

1. A reproduction apparatus comprising:
an acquisition part configured to acquire a transmitted stream;
a buffer configured to store the acquired stream;
a decoding part configured to perform the process of decoding the stream coming from said buffer; and
a control part configured such that if the amount of said stream occupying said buffer is below a predetermined reference value, said control part controls the frame rate of frames for reproduction acquired through the decoding process to be a lower frame rate than normal and that if the amount of said stream occupying said buffer reaches said reference value, said control part controls the frame rate of said frames to become the normal frame rate.

2. The reproduction apparatus according to claim 1, wherein, if the amount of said stream occupying said buffer is below said reference value, said control part varies said lower frame rate continuously in accordance with the ratio of the amount of said stream occupying said buffer to the capacity of said buffer.

3. The reproduction apparatus according to claim 2, further comprising
a video conversion part configured such that if the amount of said stream occupying said buffer is below said reference value, said video conversion part generates interpolation frames using those video frames at said lower frame rate which are acquired through said decoding process and inserts the generated interpolation frames into the video frames at said lower frame rate for frame rate conversion.

4. The reproduction apparatus according to claim 3, wherein said video conversion part generates said interpolation frames and inserts the generated interpolation frames into said video frames at said lower frame rate for conversion into said normal frame rate.

5. The reproduction apparatus according to claim 3, further comprising
an audio conversion part configured such that if the amount of said stream occupying said buffer is below said reference value, said audio conversion part converts the pitch of an audio signal corresponding to audio frames synchronized with those video frames at said lower frame rate which are acquired through said decoding process, thereby raising the audio pitch.

6. The reproduction apparatus according to claim 1, wherein
said reproduction apparatus is a reception apparatus configured to receive a digital television broadcast signal, and
said acquisition part acquires a digital television broadcast stream corresponding to a selected channel.

7. A reproduction method for use with a reproduction apparatus having a buffer, said reproduction method comprising
causing said reproduction apparatus to:
acquire a transmitted stream;
store the acquired stream into said buffer;
perform the process of decoding the stream coming from said buffer;
if the amount of said stream occupying said buffer is below a predetermined reference value, then control the frame rate of frames for reproduction acquired through the decoding process to be a lower frame rate than normal; and
if the amount of said stream occupying said buffer reaches said reference value, then control the frame rate of said frames to become the normal frame rate.

8. A program for causing a computer to function as:
an acquisition part configured to acquire a transmitted stream;
a buffer configured to store the acquired stream;
a decoding part configured to perform the process of decoding the stream coming from said buffer; and
a control part configured such that if the amount of said stream occupying said buffer is below a predetermined reference value, said control part controls the frame rate of frames for reproduction acquired through the decoding process to be a lower frame rate than normal and that if the amount of said stream occupying said buffer reaches said reference value, said control part controls the frame rate of said frames to become the normal frame rate.
